(19) United States
(12) Patent Application Publication
(10) Pub. No.: US 2012/0008673 A1
(43) Pub. Date: Jan. 12, 2012

(54) System, Method, and Apparatus for Detecting and Classifying Artifacts in Digital Images and Video

(75) Inventor: Nitin Suresh, Atlanta, GA (US)

(73) Assignee: VQLink Incorporated, Atlanta, GA (US)

(21) Appl. No.: 13/179,726

(22) Filed: Jul. 11, 2011

Related U.S. Application Data
(60) Provisional application No. 61/363,439, filed on Jul. 12, 2010.

(51) Int. Cl. H04N 7/26

(52) U.S. Cl. 375/240.01

(57) ABSTRACT

A system, method, and apparatus for detecting and classifying artifacts in digital images and video is described. In one aspect, a video quality meter is described for detecting a classifying artifacts in digital video, including a parsing module that parses a video data stream into at least one subsample region, an initial artifact scoring module that computes a coarse interlace artifact score for the at least one subsample region, a coarse score modification module that compares the coarse interlace artifact score with previous coarse interlace artifact scores, to produce a modified coarse interlaced artifact score, an extraction module that processes the subsample region to extract local and global levels of spatial and temporal details of the subsample region and generate local and global spatial and temporal masks, a masking module that performs granular score modification based on the modified coarse interlaced artifact score and the local and global spatial and temporal masks, to provide masked artifact scores, and a combining module that combines the masked artifact scores to output a final interlaced artifact score.

### CROSS-REFERENCE TO RELATED APPLICATION

This application claims the benefit of U.S. Provisional Application No. 61/363,439, filed Jul. 12, 2010, the entire contents of which is hereby incorporated herein by reference.

### FIELD OF THE INVENTION

The present invention generally relates to enhancement of video communications, to a system, method, and apparatus for the enhancement, adaptation, and optimization of a video communications system incorporating video quality measurement and characterization, and to a system for detection of video artifacts.

### BACKGROUND

Compared to years ago, video reaches us today in new ways. For example, video reaches us in alternative coding formats and over alternative distribution networks from different sources. Among TV monitors, computer screens, and mobile client displays, video resolution formats such as high definition (HD), standard definition (SD), common intermediate format (CIF), and quarter common intermediate format (QCIF) may co-exist, with an overall trend towards HD wherever possible, including in the modality of connecting a mobile client to an artifact-intolerant large monitor. With the move to digital transmission of video, cable and telecommunication video service providers (VSPs) have increased the number of digital video transmissions. The traditional workhorse of video compression, the MPEG2 coding format, is giving way to more bitrate-efficient and robust compression technologies such as H.264. The coax cable network is yielding ground to alternative communication networks including satellite and the Internet. Finally, terrestrial VSPs are augmenting traditional long-tail broadcast and video on demand (VOD) content with niche and/or localized content originated on the Internet, to gain a competitive advantage over satellite VSPs. These trends have resulted in a greater number and diversity of channels as well as increased variability in the quality of content delivered to the end user.

Given the above-described heterogeneous and complex scenarios for video distribution—and increasing consumer expectations for high-quality video—it is becoming increasingly important to optimize channel and network capacity and performance for video distribution in an intelligent and adaptive manner. In particular, any optimization should be context-aware. For example, for any optimization to be effective, it is necessary to have knowledge about a source of service degradation (such as compression-related artifacts, network-related artifacts, or interlace-related artifacts), the location of the service degradation (such as a last link in the end-to-end network or an earlier link), and the source of the complexity of the video content (such as genre-related or video processing-related). One key to context-awareness is an understanding of the content itself, at any part of a network from source to sink. In other words, an important aspect of context-awareness is the evaluation of content quality as perceived by an end user.

Various methods for evaluating Video Quality (VQ) are known in the art and are described, for example, in U.S. Pat. No. 6,898,321 B1, issued May 24, 2005, and International Application Nos. PCT/US2002/031272, filed Oct. 1, 2002, PCT/GB2006/004155, filed Nov. 7, 2006, PCT/CH2005/000771, filed Dec. 23, 2005, PCT/US2007/078501, filed Sep. 14, 2007, and PCT/US2007/010518, filed May 1, 2007.

While the long-standing problem of defining and automatically measuring VQ is becoming more important, VQ is simply defined according to a reflection of end user perception (i.e., Video QoS). The definition of VQ transcends lower level parameters such as resolution and screen type, although it is not independent of these parameters. One important parameter of VQ is the (inverse) relationship of VQ to unnatural artifacts, including artifacts related to compression and network errors. In this context, automatic measurement of VQ is difficult in that end user reactions to artifacts are difficult to model. This modeling difficultly becomes even greater in circumstances where a VQ measurement system has no access to an original video signal or source. A VQ meter that does not rely upon an original video signal or source is said to be a “no-reference” VQ meter.

Notwithstanding the challenging nature of VQ measurement, VQ assurance, like Information Security, is a key and central attribute for all competitive VSPs. To date, the video industry has largely depended on a best-effort combination of (a) static test equipment, (b) proxies for video quality such as packet loss and jitter, and (c) a small number of human experts (so-called “golden eyes”) in a laboratory or data center inspecting video examples. The video industry is seeking an agile, always-on, real-time

VQ assurance toolset that is automatic, reflective of user experience, and capable of being placed anywhere in a communications network from source to sink. It is also important that VQ assurance technology be technology-neutral and agnostic to encoding, networking, and display technologies, while being flexible enough to reflect peculiarities that relate to end user experience.

Ideally, VQ assurance technology should be sensitive to artifacts such as “combing” or “mice-teeth” caused by coding or interlace coding errors, coding or interlace coding at a specified level of spatial-temporal detail, or coding or interlace coding followed by post-processing algorithms such as frame-rate conversion or de-interlacing. Further, VQ assurance technology should be sensitive and scalable to new types of artifacts that arise as new technologies emerge for compression and network distribution. For example, in MPEG2-based distribution, artifacts are rather well characterized by blockiness and streakiness while, in H.264-based distribution, artifacts are more diverse and subtle. As a result of new compression and network distribution technologies, detecting and classifying artifacts is likely to become more difficult, as is avoiding Type 1 errors, such as missing artifacts that would be noticed by a user, and Type 2 errors, such as declaring artifacts that are in fact not visible to the user.

In this context, what is needed is a multi-dimensional no-reference algorithm for the measurement of video quality algorithm which does not rely upon an original source of content for a direct comparison.

### SUMMARY

The VQ meter and assurance system of the present invention is directed to facilitating efficient detection of artifacts in images or video. In one embodiment, a VQ assurance system comprises a no-reference VQ meter that may be located anywhere in a communications network.

Embodiments of the present invention include a VQ meter for detecting a classifying artifacts in digital video, including a parsing module that parses a video data stream into at least one subsample region, an initial artifact scoring module that computes a coarse interlace artifact score for the at least one subsample region, a coarse score modification module that compares the coarse interlace artifact score with previous coarse interlace artifact scores, to produce a modified coarse interlaced artifact score, an extraction module that processes the subsample region to extract local and global levels of spatial and temporal details of the subsample region and generate local and global spatial and temporal masks, a masking module that performs granular score modification based on the modified coarse interlaced artifact score and the local and global spatial and temporal masks, to provide masked artifact scores, and a combining module that combines the masked artifact scores to output a final interlaced artifact score.

Embodiments of the present invention also include a method for detecting a classifying artifacts in digital video, including parsing a video data stream into at least one subsample region, computing a coarse interlace artifact score for the at least one subsample region, comparing the coarse interlace artifact score with previous coarse interlace artifact scores, to produce a modified coarse interlaced artifact score, processing the subsample region to extract local and global levels of spatial and temporal details of the subsample region and generate local and global spatial and temporal masks, performing granular score modification based on the modified coarse interlaced artifact score and the local and global spatial and temporal masks, to provide masked artifact scores, and a combining the masked artifact scores to output a final interlaced artifact score.

Features and advantages of the present invention, as well as the structure and operation of the various embodiments of the present invention, are described in detail below with reference to the accompanying drawings. It is noted that the present invention is not limited to the specific embodiments described herein. Additional embodiments will be apparent to persons skilled in the relevant art(s).

### BRIEF DESCRIPTION OF THE DRAWINGS

Aspects, objects, and features of the present invention will become apparent from the following detailed description, read in conjunction with and reference to the accompanying drawings, where:

FIG. 1 illustrates a graph of artifacts measured over time;

FIG. 2 illustrates an operational environment of a VQ assurance system according to an embodiment of the present invention;

FIG. 3 illustrates a block diagram of a VQ meter according to an embodiment of the present invention;

FIG. 4 illustrates an example of defining spatial-temporal subsample regions for interlace artifact detection and classification; and

FIG. 5 illustrates an example block diagram of an initial artifact scoring module according to an embodiment of the present invention.

### DETAILED DESCRIPTION

The VQ meter and assurance system of the present invention provides an adaptable and scalable solution for enhancing video communications based on intelligent video quality measurements. The VQ meter of the present invention does not depend on the availability of an original source image or video, as in full-reference VQ technology, or a signature of the original source image or video, as in partial-reference VQ technology.

Embodiments of the present invention include a VQ meter using a hybrid approach including both bit-stream and decoded-pixel processing. As a result, video quality may be determined at different points of a video distribution network and on multiple computing platforms. The VQ meter and assurance system of the present invention is also designed to provide future-proof capabilities as new technologies are developed.

While most of the detailed description below focuses on one-way video communications, it is noted that the present invention may also apply to two-way video communications with additional considerations such as overall latency levels in two-way communications. It should also be noted that the architectures described according to the present invention may also be used with alternative technologies for VQ measurement, such as full-reference and partial reference VQ measurement technologies.

Regardless of the VQ measurement used, the VQ meter and assurance system of the present invention is capable of detecting interlace artifacts based on several types of feedback. Additionally, as new types of interlace artifacts associated with new encoding, decoding, and network technologies are presented, the methods and systems of the present invention may be used to monitor VQ according to the same principles to achieve good results in VQ metering.

In the drawings, like reference numerals designate like or corresponding, but not necessarily identical, elements throughout.

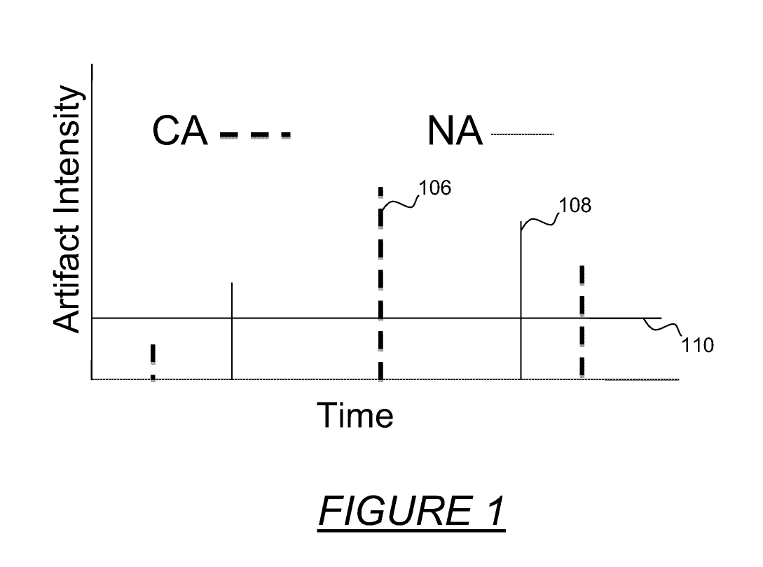

FIG. 1 illustrates an example graph of artifact intensity versus time in a video communication system. It is noted that FIG. 1 may also be illustrated as artifact intensity versus, for example, events, network location, or specific device(s). Artifact intensity may be depicted, for example, by an amount or level of compression artifacts (CA) 106 and an amount or level of network artifacts (NA) 108. Compression artifacts are generally caused by an encoder when compressing video data. Network artifacts are generally caused by packet losses during video data transmission and delivery. Examples of compression artifacts include blockiness, blurriness, choppiness, and dropped frames, among others.

In one example of identifying artifacts for VQ metering, levels of compression and network artifacts may be compared with a visibility threshold 110 to determine artifact levels detectable by end users (i.e., human end users). An appropriate level for the visibility threshold 110 may be determined empirically by those skilled in the art using subjective and objective measurements known in the art. In the context of artifacts detectable by end users, the VQ meter and assurance system of the present invention may supply information sufficient to signify that video degradation may affect a user's perception of video, rather than simply data indicating that a degradation has occurred. To the extent degradation has occurred but does not degrade the viewing experience of the user, embodiments of the VQ meter and assurance system of the present invention may not take any action to alter encoding, decoding, and network settings.

From the basic CA 106 and NA 108 metrics, their behavior over time, and other metrics known in the art, additional metrics may be derived such as mean time between visible artifacts (MTBA), as a function of time. Additionally, the basic CA 106 and NA 108 metrics may be further classified into detailed artifact taxonomies such as blockiness, blurriness, choppiness, interlace artifacts for CA, streakiness and stuck frames for NA, and bitstream errors. Indications of bitstream errors may occur when network level errors are flagged, such as when MPEG bitstream errors occur at the network level. Indications of bitstream errors may further help to compare packet loss—a traditional proxy for video artifact levels—against network-caused video artifact levels. Since estimations of artifact taxonomies are approximate in some sense, indications of artifact taxonomies are preferably provided by the present invention when high levels of confidence are assessed, based on, for example, measured metrics compared to thresholds or other filtering methods described below.

Further extrapolating from the basic CA 106 and NA 108 metrics, according to embodiments of the invention, information about video-content, video-content networks, and video-content processing may be determined. For example, information related to frame rate, packet loss rate, delay and jitter, codec type, interlacing type, and de-interlacing information may be extrapolated from or representative in a final artifact score determined by the VQ meter and assurance system of the present invention.

An ability to identify classes of the basic CA 106 and NA 108 metrics is one aspect of the present invention, but is not necessary for the implementation of the present invention. Further, VQ information may be provided by the VQ meter and assurance system of the present invention both off-line and in real-time, in deterministic and statistical forms, and in feed-back as well as feed-forward modes.

The VQ meter and assurance system of the present invention may also identify various types of actionable artifacts, especially interlace artifacts. As an example, the various types of actionable artifacts identified according to embodiments of the present invention may be caused by encoder errors or post-processing algorithms and may not strictly fall in either the basic CA 106 and NA 108 metric categories. In one aspect, the VQ meter and assurance system of the present invention may classify interlace artifacts due to odd and even fields of interlaced video being swapped. In another aspect, the VQ meter and assurance system of the present invention may detect and classify interlace artifacts due to interlaced coding, reversal and/or interlaced coding followed by post processing, attempted de-interlacing, telecine, or inverse-telecine operations. Finally, the present invention may be practiced without identifying and providing particular artifact diagnostics, for example, according to a single indication that video degradation is detected.

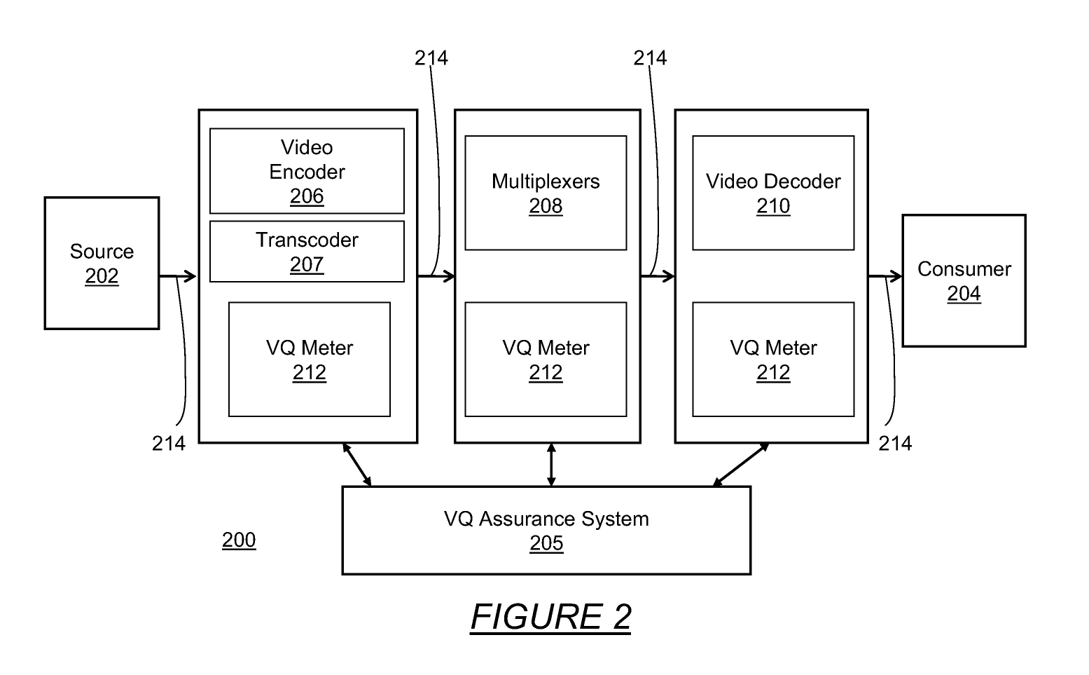

FIG. 2 illustrates an example operational environment 200 for end-to-end video communications, according to an embodiment of the present invention. The operational environment 200 includes a source of video information/content 202, at least one video encoder 206, at least one video transcoder 207, multiplexers 208, at least one video decoder 210, a consumer of video content 204, one or more VQ meters 212, and a VQ assurance system 205. The elements of the operational environment 200 are communicatively coupled or connected to each other by a network 214, such as, but not limited to, wired networks, wireless networks, public and private packet-based networks, optical networks, switched telephone networks, and combinations thereof. It is further noted that the operational environment 200 may omit one or more of the video encoder 206, the transcoder 207, the multiplexers 208, the video decoder 210, the VQ meters 212, and the VQ assurance system 205.

As illustrated in FIG. 2, several video subsystems may exist between the source of video information/content 202 and the consumer of video content 204. The first subsystem includes at least one video encoder 206 that compresses input video data, to prepare for distribution of the video data over capacity-limited networks. The first subsystem may also include at least one video transcoder 207 that further compresses or restores a higher bit rate stream depending on requirements or constraints of the network 214 and devices coupled to the network 214, such as consumer-side clients or set-top boxes. The second subsystem includes multiplexers 208 that pack the greatest possible number of video channels into an available distribution bandwidth of the network 214. For example, in cable video distribution systems, multiplexing is performed to satisfy the requirements of a 38 Mbps Quadrature Amplitude Modulation (QAM) services. The third subsystem includes at least one video decoder 210 that decodes video data for delivery of video content to the consumer of video content 204.

In one embodiment, each subsystem 206, 207, 208, and 210 is functionally connected to a VQ meter 212, so that characteristics of video quality can be dynamically measured throughout the operational environment 200. A VQ meter 212 may reside, for example, at each respective subsystem and/or may remotely with the VQ assurance system 205 and access and measure the operational environment 200 at any point.

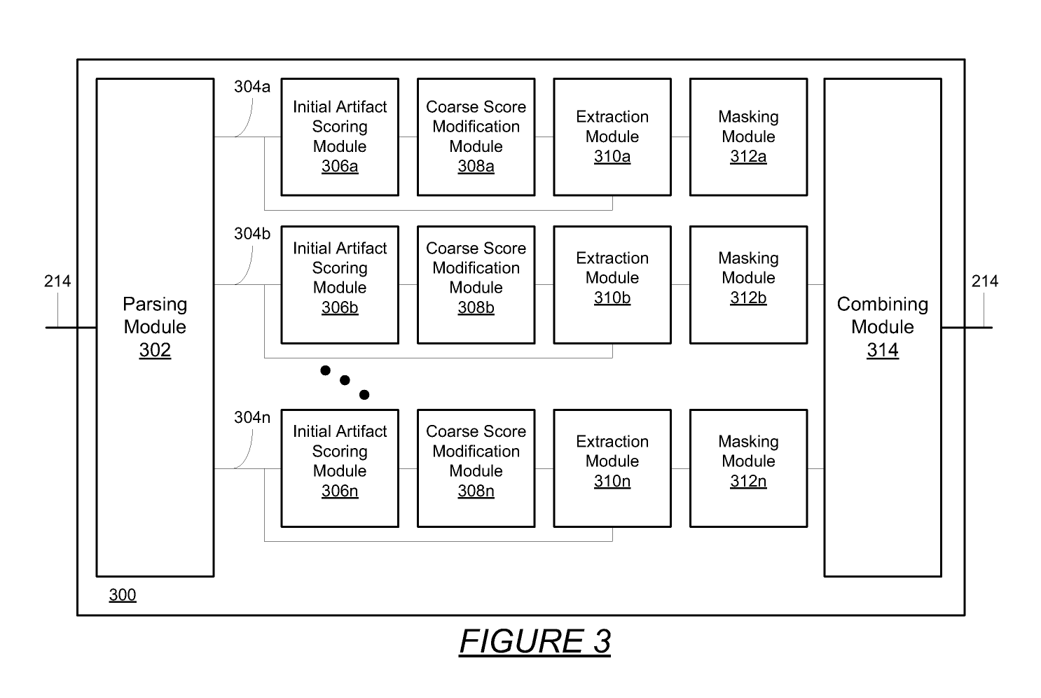

FIG. 3 illustrates a VQ meter 300 as an example embodiment of one of the VQ meters 212 illustrated in FIG. 2. The VQ meter 300 performs artifact detection and classification, such as interlace artifact detection and classification. In the example illustrated in FIG. 3, the VQ meter 300 comprises a parsing module 302, a set of initial artifact scoring modules 306a-n, a set of course score modification modules 308a-308n, a set of extraction modules 310a-n, a set of masking modules 312a-n, and a combining module 314. It is noted that, depending upon the implementation of the VQ meter 300, the parsing module 302 may comprise one or more parsing modules 302. Likewise, the set of initial artifact scoring modules 306a-n may comprise a single initial artifact scoring module 306a, and the other modules 308, 310, and 312 may be similarly configured.

In operation of the VQ meter 300, the parsing module 302 parses an incoming video data stream received via the network 214 into smaller subsample regions 304a-n that represent spatial-temporal subsamples of the incoming video data stream. The subsample regions 304a-n may be non overlapping, overlapping, or identical regions in space and time to facilitate parallel processing.

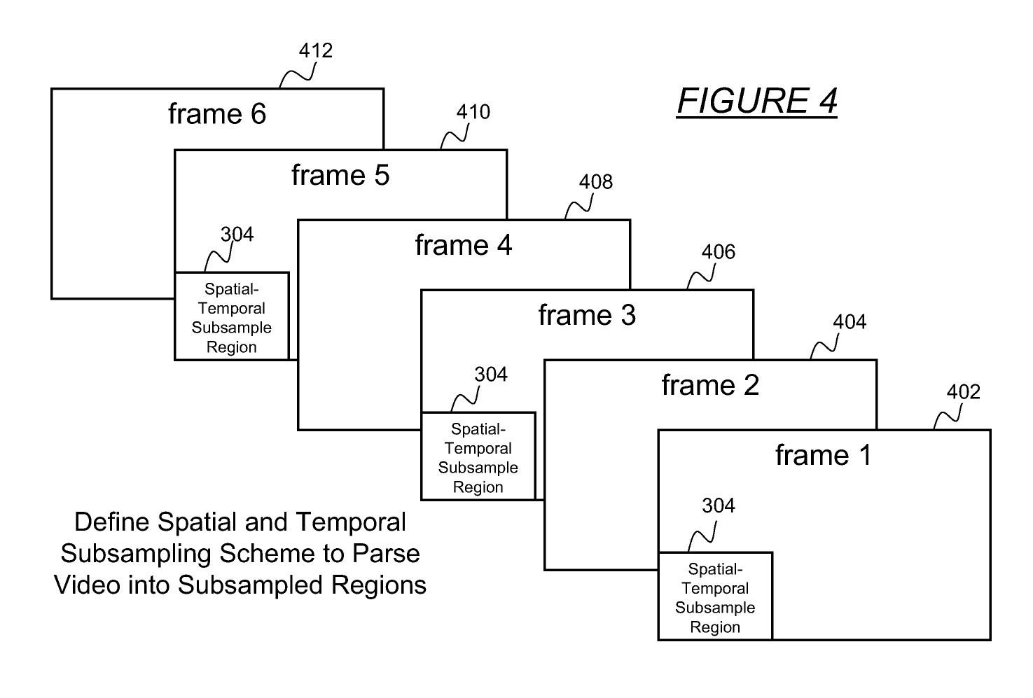

FIG. 4 illustrates an example of parsing a received video data stream having frames 402, 404, 406, 408, 410, and 412 into spatial-temporal subsample regions 304 by the parsing module 302. A frame 402 of the incoming video data stream is subsampled to produce a spatial-temporal subsample region 304 for artifact detection and classification processing. Among various embodiments of the present invention, the subsample region 304 may be defined in several ways. For example, the subsample region 304 may be defined as a temporal-only subsample of the frame 402, where the subsample region 304 extends spatially to the entire frame 402, but occurs only in select frames over time such as frame 3 406, frame 5 410, and so on. Alternatively, the subsample region 304 may be defined as a spatial-only subsample, where the subsample region 304 is a spatial subset of each frame and occurring in every frame in time. Still further, the subsample region 304 may be defined according to both spatial and temporal subsampling, by combining both the previously described approaches (as illustrated in the FIG. 4). When spatially subsampled, it is noted that spatial subsampling may be concentrated in a specific region of a frame, distributed in any region of the frame, or cover an entirety of the frame. It is also noted that different spatial regions may be used in each subsampled frame and that temporal subsampling may be regular (periodic in time), non-regular in time (and even random), or may tied to events or signatures in the video content such as commercials, scene transitions, or other unique content within the video. In the simplest embodiment, spatial subsampling is defined for a factional region of an entire frame in a same location among a frames occurring regularly in time, as illustrated in FIG. 4.

Returning to FIG. 3, a single subsample region 304a may be defined and processed by the VQ meter 300 for artifact detection and classification and/or interlace artifact detection and classification, as described below, with the understanding that the same applies to each parallel path “b” through “n” in FIG. 4.

Each initial artifact scoring module 306 computes a coarse interlaced artifact score for a subsample region 304. As one example, the coarse interlaced artifact score may comprise an integer number representing a certainty metric that an artifact exists in a subsample region 304. The initial artifact scoring module 306 may generate coarse interlaced artifact scores periodically based on a period of time or for each of a predetermined number of frames of video data, for example, based on available processing time, power constraints, and/or other pragmatic variables.

Each coarse score modification module 308 compares coarse interlaced artifact scores produced by an initial artifact scoring module 306 with previously determined and stored coarse interlaced artifact scores. As one example, each coarse score modification module 308 produces a modified coarse interlaced artifact scores in place of a coarse interlaced artifact score, for example, by retaining a current coarse interlaced artifact score only if M (where M is a positive integer) previous coarse interlaced artifact scores were positive, and, otherwise, zeroing a value of the current coarse interlaced artifact score. Thus, for a case in which M=3 and the initial artifact scoring module 306 computes the following group of a coarse interlaced artifact scores: 1, −1, −2, 4, 2, −1, 0, 1, 4, 9, 20, 4, 5, −1, 3; the coarse score modification module 308 outputs the following group of modified coarse interlaced artifact scores: 0, 0, 0, 0, 0, 0, 0, 0, 0, 0, 20, 4, 5, 0, 0. That is, among the group of modified coarse interlaced artifact scores, 20 was the first non-zero modified coarse interlaced artifact score, because the previous three coarse interlaced artifact scores (i.e., 1, 4, and 9) were positive. It is noted that a string of positive coarse interlaced artifact scores indicates an increased confidence that errors, artifacts, or interlaced artifacts are present in a subsample region 304, and the value of M may be selected to be greater or less than 3 based upon an empirical and/or statistical analysis for preferred operation.

Each extraction module 310 extracts local and global levels of spatial and temporal details from a subsample region 304 and generates local and global spatial and temporal masks. That is, each extraction module 310 determines levels of spatial and temporal detail to apply as visual masking in the masking module 312.

Examples of spatial-temporal masks generated by the extraction module 310 include, but are not limited to:

1) spatial-detail=mean(abs difference across neighbors)*function(mean_luma); where mean(abs difference across neighbors) represents a simple average of, for each pixel in a spatial-temporal region, an average of an absolute difference between a pixel in the spatial-temporal region and all neighbors of the pixel (i.e., a pixel to the left, a pixel to the top-left, a pixel directly above, etc.), and function(mean_luma) represents a piece-wise line segment joining [{m=0,f=0}, {m=60,f=1}, {m=180,f=1}, {m=255,f=0}] where m represents pixel values on an X axis and f represents pixel values on the Y axis. That is, the piece-wise line segment would connect the points (0,0) and (60,1) using a line; connect the points (60,1) and (180,1) using a line, and connect the points (180,1) and (255,0) using a line.

2) temporal-detail=mean(inter-frame pixel difference); where mean(inter-frame pixel difference) represents a simple average of differences between corresponding pixels of two frames; and

3) combined spatial-temporal detail=product of spatial-detail and temporal-detail.

Each masking module 312 performs granular score modification based on modified coarse interlaced artifact scores produced by the coarse score modification module 308 and the local and global spatial and temporal masks generated by the extraction module 310, to provide masked artifact scores. Masking the modified coarse interlaced artifact scores based on the local and global spatial and temporal masks provides a more accurate representation of artifacts visible to viewers. For example, a sufficient presence of noise can be used to mask out an indication of interlaced artifacts. Alternatively, the local and global spatial and temporal masks may be generated based on one or more regions of interest in a subsample region 304, such as a region including a person's face.

In one embodiment, each masking module 312 performs granular score modification by multiplying modified coarse interlaced artifact scores by the combined spatial-temporal detail value described above. Alternatively or additionally, granular score modification may include an application of weighting factors to the local and global spatial and temporal masks for calculation of the combined spatial-temporal detail value, a function alternate to the piece-wise line segment, or other combinations thereof.

The combining module 314 combines the masked artifact scores to output a final interlaced artifact score. That is, the combining module 314 combines outputs of all parallel processing paths “a” through “n” to output a final interlaced artifact score. In one embodiment, the combining module 314 applies respective weights to each parallel processing path and computes a final interlace artifact score for the video data stream being processed. For example, the combining module 314 may apply greater weights based on more important spatial-temporal regions 304a-n. Alternatively, in another example, the combining module 314 may average the outputs across the parallel processing paths.

The combining module 314 may also identify and indicate various types of actionable artifacts, especially interlace artifacts, based on the final interlaced artifact score. For example, based on the final interlaced artifact score, the combining module 314 may identify actionable artifacts caused by encoder errors, post-processing algorithms, interlace artifacts due to odd and even fields of interlaced video being swapped, interlaced coding errors, reversal and/or interlaced coding errors followed by post processing, attempted de-interlacing, telecine, or inverse-telecine operations.

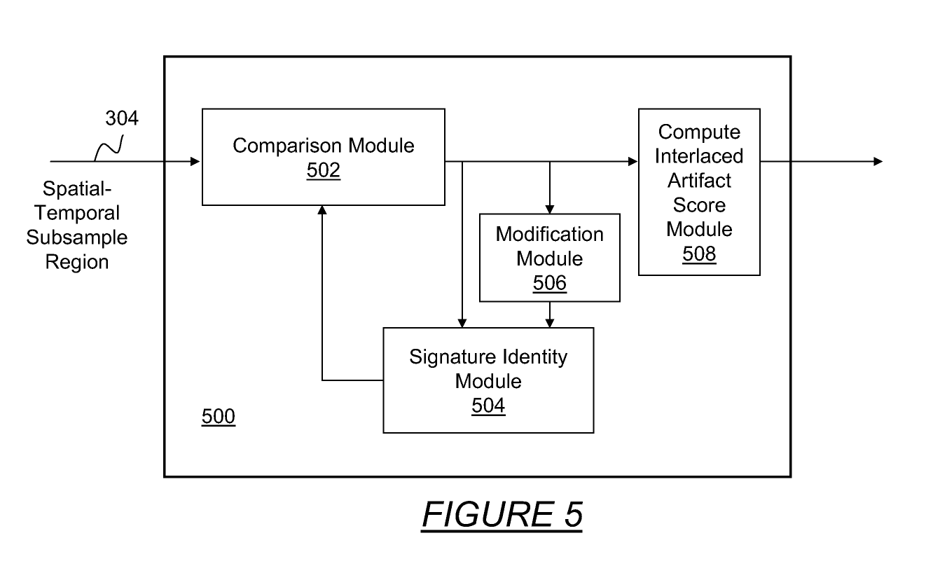

FIG. 5 illustrates an example block diagram 500 of the initial artifact scoring module 306 illustrated in FIG. 3. The initial artifact scoring module 306 includes a comparison module 502, a frame modification module 506, a signature identity module 504, and a compute interlaced artifact score module 508. It is noted that various subsystems in the operational environment 200 may induce visual errors such as mixing fields or rows, degrading VQ. The initial artifact scoring module 306 operates based on the recognition that, in a subsample region 304 in which odd and even fields or rows have been swapped due to an error in the operational environment 200, a mean of an absolute difference between two rows 4n+1 and 4n+2 may be larger than a mean of an absolute difference between rows 4n and 4n+3, where n is a positive integer. According to the present invention, the initial artifact scoring module 306 measures this unnatural difference to generate a coarse interlaced artifact score.

In operation, the comparison module 502 generates a difference metric related to the VQ of a subsample region 304. In one embodiment, the comparison module 502 compares a difference in VQ between a signature of a subsample region 304 and a signature of a modified subsample region, where the modified subsample region is generated by the frame modification module 506 and the signatures of the subsample and modified subsample regions 304 are generated by the signature identity module 504. In additional embodiments, the comparison module 502 may directly generate the difference metric based on the subsample region 304 or a signature of the subsample region 304.

The signature identity module 504 generates a signature by calculating a mean absolute difference between values of corresponding pixels of two fields or rows (i.e., rows 4n+1 and 4n+2) of a subsample region 304. It is noted that the signature identity module 504 may generate a signature for pairs of fields or rows over a non-overlapping range of fields or rows of the subsample region 304. As a more specific example, rows of a subsample region 304 may include rows C0, C1, C2, . . . , and Cn, where each row consists of pixels Pn,0, Pn,1, Pn,2, . . . , and Pn,m, the n subscript designates row number, the m subscript designates pixel number, and n and m are integers. In this context, the signature identity module 504 generates a “signature” between rows C1 and C2 according to Signature(C1,C2)=mean(|P1,0-P2,0|, |P1,1-P2,1|, . . . , |P1,m-P2,m|), where “mean” denotes a simple average. The range of fields or rows over which signatures are generated by the signature identity module 504 may vary according to embodiments of the present invention and can be determined by those skilled in the art based on empirical or statistical results, computational requirements or limitations, accuracy, and video content.

It is noted that the VQ of a video (A) may be assessed by swapping fields or rows of pixels in the video (A) to arrive at video (B), and analyzing which video (A) or (B) appears more natural. If video (B) looks more natural, it is likely that video (A) includes swapped fields or rows which degrades the VQ of the video (A). Thus, the frame modification module 506 progressively swaps, in a sequence, pixel-positions of odd and even fields or rows of pixels in a subsample region 304 to generate a modified subsample region 304, so that signatures of the modified subsample region 304 may be calculated by the signature identity module 504.

As a non-limiting example of progressive swapping by the frame modification module 506, an odd field may refer to all pixels of an odd row of pixels in a pixel matrix, and an even field may refer to all pixels of an even row of pixels in the pixel matrix. As described above, rows of a subsample region 304 may include rows C0, C1, C2, . . . , and

Cn, where each row consists of pixels Pn,0, Pn,1, Pn,2, . . . , and Pn,m. In a natural or original image, C0 will be “closer” to C1 than C0 is to C2. In other words, a mean of an absolute difference between values of corresponding pixels of rows C0 and C1 will be less than a mean of an absolute difference between values of corresponding pixels of rows C0 and C2 in a natural or original image. That is, a “signature” of C0 and C1 will generally be less than a “signature” of C0 and C2 in a natural or original image.

In general, in an original or natural image, rows C4n and C4n+3 will not be as “close” as (i.e., will have a larger “signature” than) C4n+1 and C4n+2. However, if even and odd fields or rows of an original image are swapped, this property of the original image will be reversed. Thus, a comparison of signatures of a subsampled region 304 and signatures of a modified subsampled region (i.e., a subsampled region 304 modified by the frame modification module 506) will, on an average, indicate whether fields of the subsampled region 304 are reversed. Thus, to detect mixing caused by a mismatch between even and odd fields or rows, the comparison module 502 may compare signatures of the subsampled region 304 generated by the signature identity module 504 with signatures of the modified subsample region 304 generated by the signature identity module 504. Based on the comparison, the comparison module 502 may determine that the operational environment 200 has induced errors and generate a difference metric indicating that the operational environment 200 has induced errors. In some embodiments, the difference metric generated by the comparison module may indicate an amount or value of errors.

It should be appreciated that the signatures generated by the signature identity module 504 are calculated using only a subsampled region 304 in the operational environment 200, without any reference to an original of the subsampled region 304 generated at the source 202. This type of no-reference VQ measurement is very practical because transmitting reference information related to an original of the subsampled region 304, such as a full or partial reference, is undesirable because of the additional processing and network overhead required to transmit the reference.

The compute interlaced artifact score module 508 computes a coarse interlaced artifact score based on the difference metric generated by the comparison module 502. The compute interlaced artifact score module 508 may compute coarse interlaced artifact scores based directly upon the difference metric generated by the comparison module 502. Alternatively, the compute interlaced artifact score module 508 may compute coarse interlaced artifact scores based on the difference metric and one or more scaling factors based on a width of a video frame, for example. Additionally, the compute interlaced artifact score module 508 may automatically set an interlaced artifact score to zero in order to minimize false alarms in the detection of interlaced video artifacts, for example, based on false alarm conditions known to those skilled in the art.

It is additionally noted that, in other embodiments, the initial artifact scoring module 306 may include respective initial artifact scoring algorithms for various artifact taxonomies such as blockiness, blurriness, choppyness, interlaced artifacts, stuckframes, streakiness, etc., and the other modules 308, 310, 312, and 314 may similarly include functions for the various artifact taxonomies. In this case, for example, the modification module 308 may compare coarse artifact scores of the same taxonomy, and the combining module 314 may combine scores of the same taxonomy.

The present invention may be implemented in hardware, software, or combinations of hardware and software. An example hardware embodiment includes a general purpose computer comprising a general purpose arithmetic processor (CPU), a random access memory (RAM), a memory, an input/output interface (I/O), and a bus. The CPU may comprise any well known general purpose arithmetic processor. The RAM may comprise any well known random access memory configured to store software programs for execution by the CPU. The memory is configured to store software programs thereon that, when executed by the CPU, direct the CPU to execute various aspects of the present invention described above. As a non-limiting example group, the memory may comprise one or more of an optical disc, a magnetic disc, a semiconductor or solid state memory (i.e., a flash based memory), a magnetic tape memory, a removable memory, or other well known memory means for storing software programs. The I/O comprises, for example, device input interfaces, device output interfaces, and network input and output interfaces for communicatively and electrically coupling the general computer to external devices and networks. The bus is configured to electrically couple the CPU, the RAM, the memory, and the I/O, for the transfer of data and instructions among the CPU, the RAM, the memory, and the I/O. In operation, the CPU is configured to load software programs stored on the memory, or memories accessible via the I/O, to the RAM. The CPU is further configured to, based on an execution of the software programs, implement various aspects, elements, and features of the present invention described above

Although embodiments of the present invention have been described above in detail, the above descriptions are provided only as examples. That is, it should be appreciated that many aspects of the present invention described above were described by way of example only and were not intended as being required or essential elements unless explicitly stated otherwise. Various modifications of, and equivalent steps corresponding to the disclosed aspects of the above-describe embodiments, may be made by a person having ordinary skill in the art without departing from the spirit and scope of the present invention defined in the following claims, the scope of which is to be accorded the broadest interpretation so as to encompass such modifications and equivalent structures.

1. A video quality meter for detecting and classifying artifacts in digital video, comprising:
a parsing module that parses a video data stream into at least one subsample region;
an initial artifact scoring module that computes a coarse interlace artifact score for the at least one subsample region;
a coarse score modification module that compares the coarse interlace artifact score with previous coarse interlace artifact scores, to produce a modified coarse interlaced artifact score;
an extraction module that processes the subsample region to extract local and global levels of spatial and temporal details of the subsample region and generate a local and global spatial and temporal mask;
a masking module that performs granular score modification based on the modified coarse interlaced artifact score and the local and global spatial and temporal mask, to provide masked artifact scores; and
a combining module that combines the masked artifact scores to output a final interlaced artifact score.
